(19) United States
(12) Patent Application Publication
(10) Pub. No.: US 2019/0301416 A1
(43) Pub. Date: Oct. 3, 2019

(54) COMBUSTOR WITH FUEL INJECTION PEG, AND GAS TURBINE HAVING SAME

(71) Applicant: DOOSAN HEAVY INDUSTRIES & CONSTRUCTION CO., LTD., Changwon-si (KR)

(72) Inventors: Dong Gon LEE, Seoul (KR); U Jin ROH, Changwon-si (KR)

(21) Appl. No.: 16/296,160

(22) Filed: Mar. 7, 2019

(30) Foreign Application Priority Data
Mar. 28, 2018 (KR) 10-2018-0036090

(51) Int. Cl. F02M 61/18; F23R 3/28

(52) U.S. Cl. CPC F02M 61/1806; F02M 2200/06; F23R 3/28

(57) ABSTRACT

A combustor includes a nozzle casing; a head end plate coupled to one end of the nozzle casing and having a plurality of supply holes through which fuel and air are respectively supplied; a nozzle assembly provided inside the nozzle casing and having a plurality of nozzles fixed to the nozzle end plate to receive the fuel and air from the supply holes and a nozzle cap having a plurality of through-holes surrounding the nozzles; and a plurality of fuel pegs disposed at predetermined intervals along an inner circumferential surface of the nozzle casing to inject the fuel into an air channel between the nozzles and the nozzle cap. The fuel peg includes a support mounted on an inner surface of the nozzle casing; and an extension extending a predetermined length inside an air channel and having a fuel injection hole formed on one side.

### CROSS REFERENCE TO RELATED APPLICATIONS

The present application claims priority to Korean Patent Application No. 10-2018-0036090, filed on Mar. 28, 2018, the entire contents of which are incorporated herein for all purposes by this reference.

### BACKGROUND OF THE INVENTION

### 1. Field of the Invention

The present invention relates to a combustor, and a gas turbine having the same.

### 2. Description of the Background Art

Generally, a contemporary gas turbine includes a compressor, a combustor, and a turbine. In such a gas turbine, the compressor compresses air, which is introduced from an air inlet, to produce a high-temperature, high-pressure compressed air, and the combustor mixes fuel with the compressed air and combusts a fuel-air mixture to produce a high-temperature, high-pressure combustion gas (working fluid), which then drives a turbine and a generator coupled to the turbine.

As shown in FIGS. 1 and 2, the combustor of the contemporary gas turbine includes a plurality of main combustion burners disposed around a pilot combustion burner, wherein the pilot combustion burner and the main combustion burner each have a pilot nozzle and a main nozzle, respectively, and the pilot combustion burner and the main combustion burners are disposed in an inner cylinder of the gas turbine.

The gas turbine operates by the principle that fuel injected through the nozzle is combusted with compressed air to generate a high temperature and high pressure combustion gas, which is then used to rotate a turbine at high speed.

Here, the combustion gas acting as a working fluid for rotating a plurality of turbine blades is generated by combusting a fuel-air mixture, which is generated by pre-mixing the fuel injected through a nozzle assembly having a plurality of nozzles with air, or by combusting fuel that is being injected directly into the air

Thus, sufficient and proper supplying of air toward the nozzles is important in the combustion in gas turbines.

Air supplied to the nozzles for premixed combustion is supplied toward a head end plate located at a rear end of the nozzle assembly and then reversely supplied to an end of the nozzles where the combustion takes place. Reverse supply of air is performed because the compressed air supplied to the nozzles is supplied from the downstream side of a combustion duct, which is composed of a liner and a transition piece, to cool the surface of the combustion duct, and is introduced into a combustor on the upstream side of the combustion duct, and this air should flow into the end of the nozzle directing toward the downstream side of the combustion duct.

In this way, a strong swirl occurs in a process whereby a flow of air for combusting fuel rapidly changes in direction at the end plate of the nozzle. The swirl includes a high velocity component that deviates from the direction of the actual flow or is directed in the opposite direction, which results in pressure loss and lowers the flow efficiency of the air.

Further, in the case of a combustor according to a related art, the fuel injection speed varies depending on an amount of fuel supply, and a difference in fuel penetration may occur. The difference in the fuel penetration may cause the fuel distribution inside the nozzle to vary, which varies the effect due to the fuel split.

Accordingly, there is a need for a technique capable of solving the above-mentioned problems with the related art.

The foregoing is intended merely to aid in the understanding of the background of the present invention, and is not intended to mean that the present invention falls within the purview of the related art that is already known to those skilled in the art.

### SUMMARY OF THE INVENTION

In an aspect of the present invention, a combustor may include a nozzle casing; a head end plate coupled to one end of the nozzle casing and having a plurality of supply holes through which fuel and air are respectively supplied; a nozzle assembly provided inside the nozzle casing and having a plurality of nozzles fixed to the nozzle end plate to receive the fuel and air from the supply holes and a nozzle cap having a plurality of through-holes surrounding the nozzles; and a plurality of fuel pegs mounted inside the nozzle casing and disposed at predetermined intervals along an inner circumferential surface of the nozzle casing to inject the fuel into an air channel between the nozzles and the nozzle cap.

The fuel peg may include a support part mounted on an inner surface of the nozzle casing and having a planar disk-shaped structure; and an extension part extending a predetermined length inside an air channel from the support part and including one side in which a fuel injection hole is formed.

The fuel peg may have a cross-sectional structure formed as either one of an oval or airfoil structure curved in a direction corresponding to the direction of air flowing along the air channel.

The combustor may further include a fuel injection hole formed in one side of the fuel peg in the direction corresponding to the direction of air flowing along the air channel. The fuel injection hole may be formed at one end of the fuel peg.

The fuel peg may include a support part mounted on an inner surface of the nozzle casing and having a planar disk-shaped structure; an extension part extending a predetermined length inside an air channel from the support part; and a fuel peg cap having a hemispherical structure mounted on one end of the extension part and including one side in which a fuel injection hole is formed. The fuel injection hole formed in the fuel peg cap may be formed in a direction corresponding to the direction of air flowing along the air channel.

Alternatively, the fuel peg may include a support part mounted on an inner surface of the nozzle casing and having a planar disk-shaped structure; an extension part having a hollow cylinder structure extending a predetermined length inside an air channel from the support part, the extension part including an upper end at which a through-hole is formed and one side at which a fuel injection hole is formed; an injection-adjusting member having a hollow cylinder structure slidably mounted in the extension part and including one side in which a plurality of through-holes are formed at regular intervals in a sliding direction; and an elastic member mounted between an upper surface of the injection-adjusting member and an inner upper surface of the extension part to provide an elastic restoring force of the injection-adjusting member in a vertical direction. Here, the combustor may further include an auxiliary guide extending convexly a predetermined distance from one end of the extension part in the direction of the through-hole formed in the upper end of the extension part; and/or may further include a sealing member mounted between a lateral surface of the injection-adjusting member and an inner surface of the extension part, wherein the injection-adjusting member has a structure corresponding to an inner structure of the extension part.

The fuel peg may further include a fuel peg cap having a hemispherical structure mounted on one end of the extension part and including one side in which a fuel injection hole is formed. The fuel injection hole formed in the fuel peg cap may be formed in a direction corresponding to the direction of the air flowing along the air channel.

The combustor may further include a curved airflow guide mounted on one side of the fuel peg to guide air flowing along the air channel. The airflow guide may have a concave portion curved convexly toward the head end plate. Alternatively, the airflow guide may have a concave portion formed in a curved surface in a shape corresponding to an inner surface of the nozzle casing. Here, the concave portion may have an arc-shaped cross section, and/or the airflow guide may be integrally coupled to the adjacent fuel peg.

In another aspect of the present invention, there is provided a gas turbine including a compressor to compress air introduced from an outside; a combustor to produce combustion gas by combusting a mixture of fuel and the compressed air; and a turbine to produce power using the combustion gas. Here, the combustor of the gas turbine is consistent with the combustor as described above.

### BRIEF DESCRIPTION OF THE DRAWINGS

FIG. 1 is a schematic side view of a conventional gas turbine to which may be applied a combustor according to the present invention;

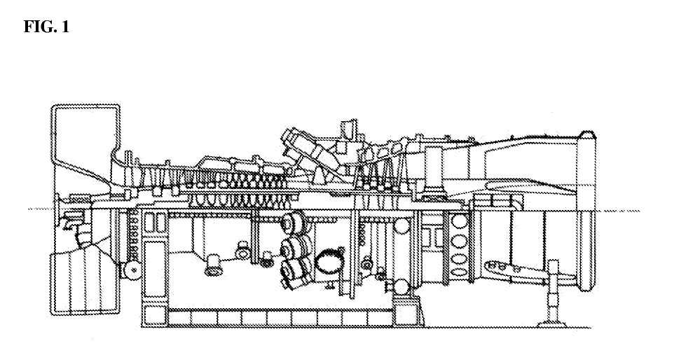

FIG. 2 is a cross-sectional view of a combustor shown in FIG. 1;

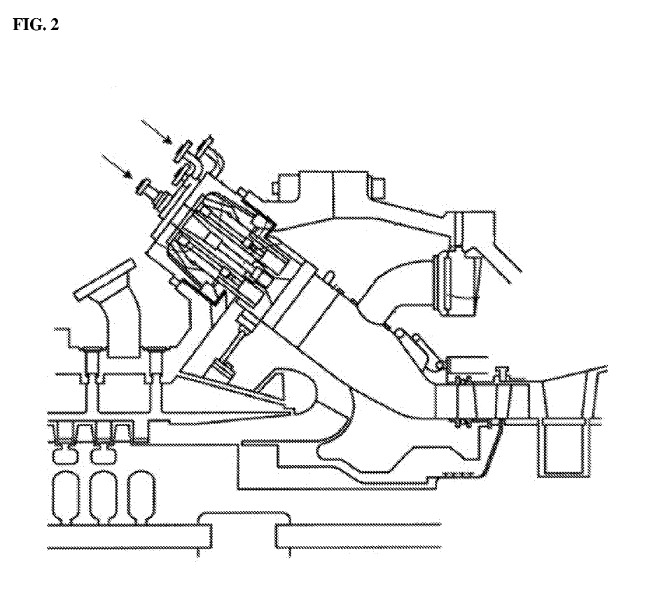

FIG. 3 is a cutaway perspective view of a portion of a combustor in accordance with an embodiment of the present invention;

FIG. 4 is a perspective view of a fuel peg of FIG. 3;

FIG. 5 is a cross-sectional view of the fuel peg according to an embodiment of the present invention;

FIG. 6 is a cross-sectional view of a fuel peg according to an embodiment of the present invention;

FIG. 7 is a cross-sectional view taken along line A-A′ of FIG. 6;

FIG. 8 is a cross-sectional view of a fuel peg according to another embodiment of the present invention;

FIG. 9 is a cross-sectional view taken along line B-B′ of FIG. 8;

FIG. 10 is a cross-sectional view of a fuel peg according to still another embodiment of the present invention;

FIG. 11 is a cross-sectional view of a fuel peg according to still another embodiment of the present invention;

FIG. 12 is a cross-sectional view of a fuel peg according to still another embodiment of the present invention; and

FIG. 13 is a cross-sectional view of a fuel peg according to still another embodiment of the present invention.

### DETAILED DESCRIPTION OF THE INVENTION

Hereinafter, exemplary embodiments of the present invention will be described in detail with reference to the accompanying drawings. It should be noted that terms used in this specification and claims should not be limited to a common meaning or a dictionary definition, but should be construed as the meanings and concepts according to technical spirit of the present invention.

It will be understood that when an element is referred to as being “on” another element, it can be directly on the other element or intervening elements may be present therebetween. Further, it will be understood that the term “comprising” or “including” specifies the presence of stated elements, but does not preclude the presence or addition of one or more other elements, unless the context clearly indicates otherwise.

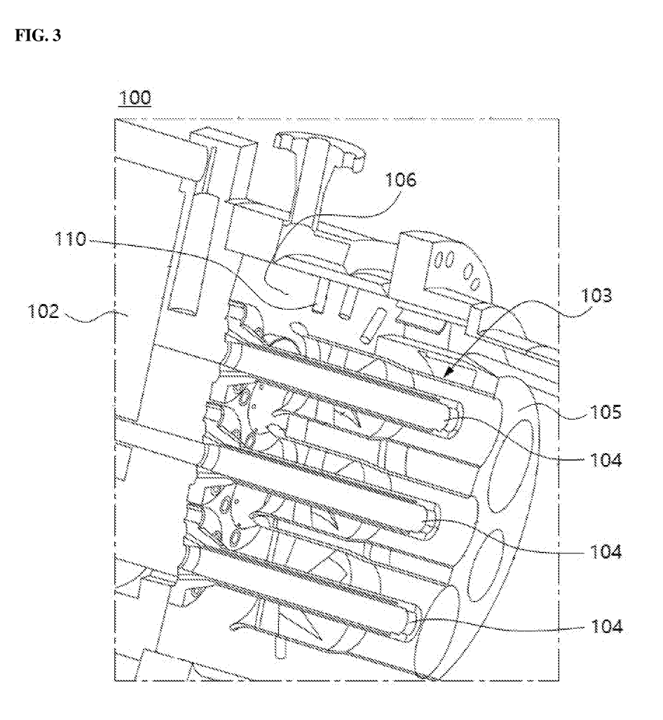

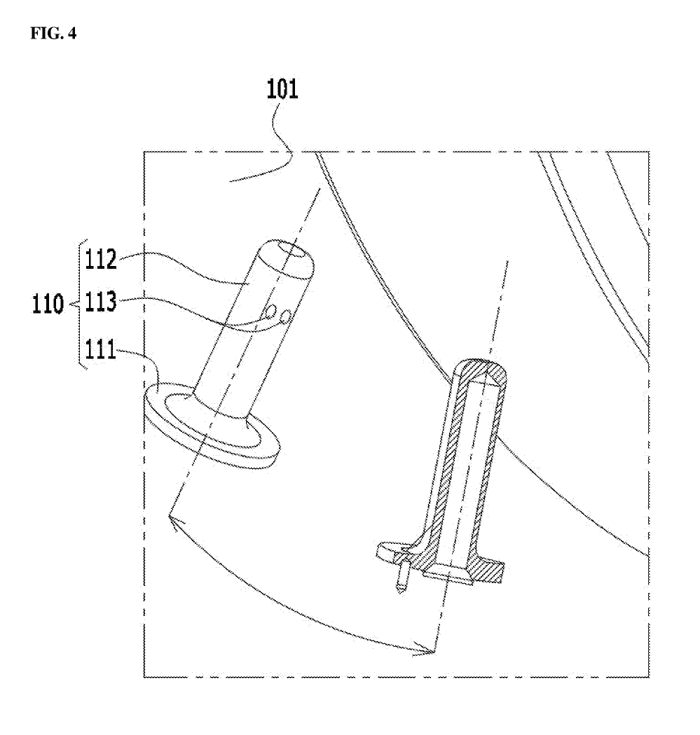

Referring to FIGS. 3 and 4, a combustor 100 according to the present embodiment may include a fuel peg 110 having a specified structure.

Specifically, the combustor includes a nozzle casing 101, a head end plate 102, and a nozzle assembly 103. The fuel peg 110 is mounted inside the nozzle casing 101 so as to inject fuel into an air channel 106 between a nozzle 104 and a nozzle cap 105.

Here, as shown in FIGS. 3 and 4, two or more fuel pegs 110 are preferably disposed at predetermined intervals along an inner circumferential surface of the nozzle casing 101.

In some cases, the fuel pegs may be disposed at irregular intervals depending on a fuel distribution for injection of fuel into a desired region. This can achieve a combustor capable of increasing combustion performance due to an increase in an air-fuel mixing ratio, and a gas turbine having the combustor.

The head end plate 102 according to the present embodiment has a structure that is coupled to one end of the nozzle casing 101 and includes a plurality of supply holes through which fuel and air are respectively supplied. The nozzle assembly 103 includes a plurality of nozzles 104 fixed to the nozzle end plate 102 in the nozzle casing 101 so as to receive fuel and air from the supply holes, and a nozzle cap 105 having a plurality of through-holes for enclosing the nozzles 104.

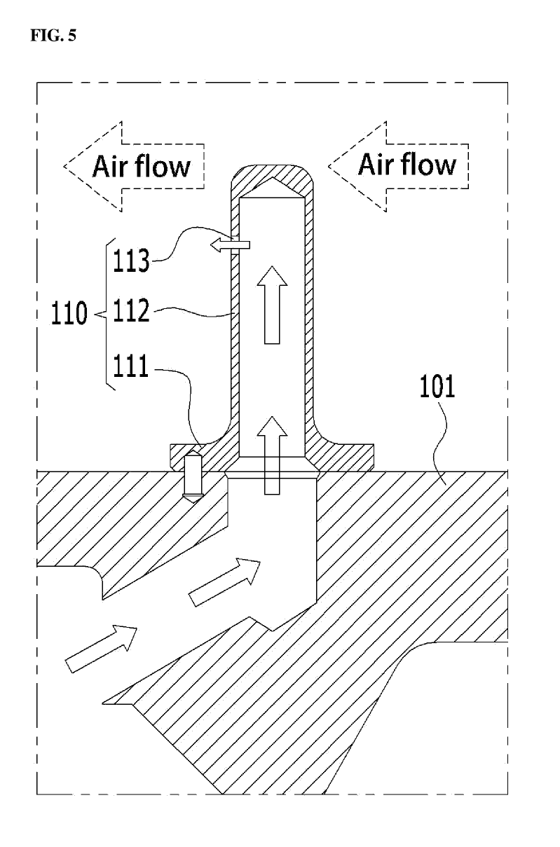

Hereinafter, the specific structure of the fuel peg 110 according to the present embodiment will be described in more detail with reference to FIGS. 5-7.

The fuel peg 110 may have a structure that includes a support part 111 and an extension part 112. Specifically, the support part 111 has a planar disk-shaped structure which is mounted on an inner surface of the nozzle casing 101. The extension part 112 has a cylindrical structure extending inside of an air channel 106 a predetermined length from the support part 111 and has one side in which fuel injection holes 113 are formed.

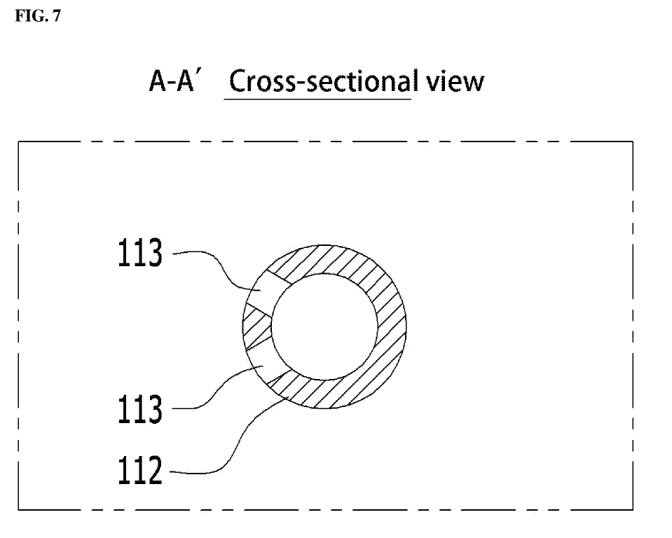

The cross section of the fuel peg 110 may have a circular shape as shown in FIG. 7, or another shape such as a curved oval or airfoil shape curved in a direction corresponding to a direction of air flowing in the air channel 106.

At this time, the fuel injection holes 113 may be formed on one side of the fuel peg 110 in a direction corresponding to the direction of the air flowing along the inside of the air channel 106, i.e., the upstream side of the fuel peg 110. Further, the fuel injection holes 113 may be formed toward one end of the fuel peg 110 and may be preferably formed at an upper end of the fuel peg 110.

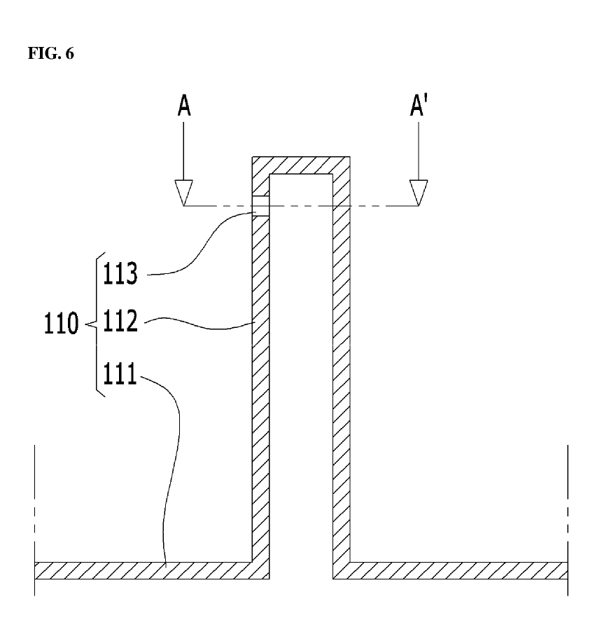

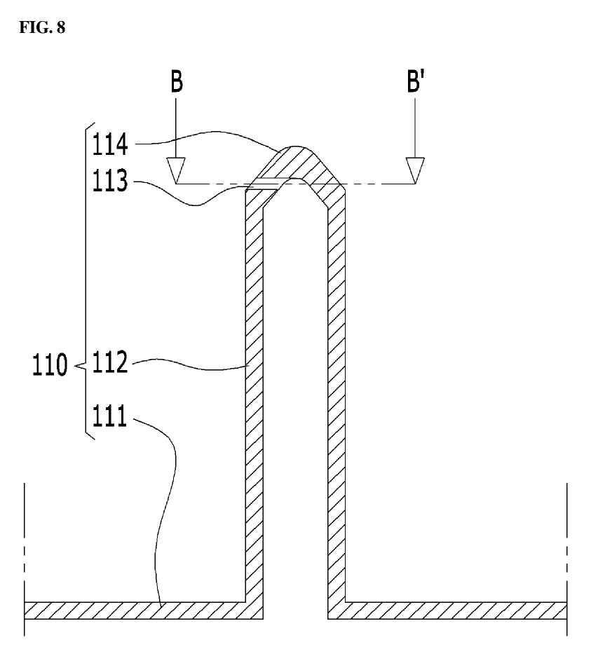

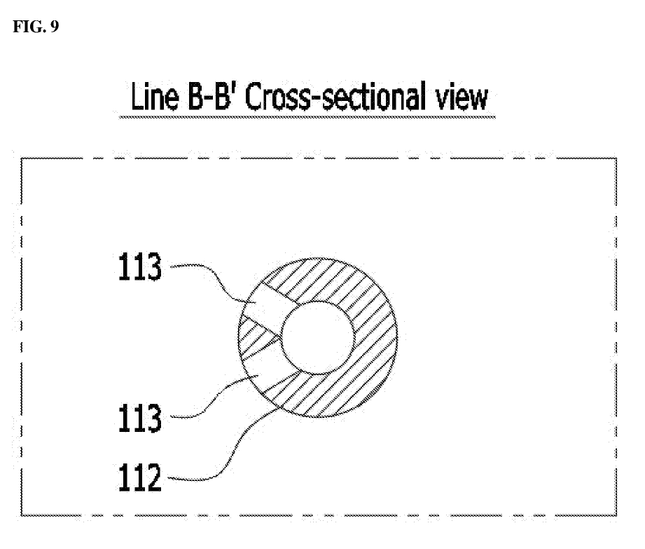

In some cases, as shown in FIG. 8 illustrating another embodiment, the fuel peg 110 may further include a hemispherical fuel peg cap 114 mounted on the distal end of the extension part 112. Here, as in the case of the fuel peg of FIG. 6, the cross section of the fuel peg 110 of FIG. 8 may have a circular shape as shown in FIG. 9, or another shape such as a curved oval or airfoil shape curved in a direction corresponding to a direction of air flowing in the air channel 106. In this embodiment, a fuel injection hole 113 may be formed on one side of the fuel peg cap 114. In this case, it is also preferable that the fuel injection hole 113 formed in the fuel peg cap 114 is formed in a direction corresponding to the direction of the air flowing along the inside of the air channel 106, as shown in FIG. 5.

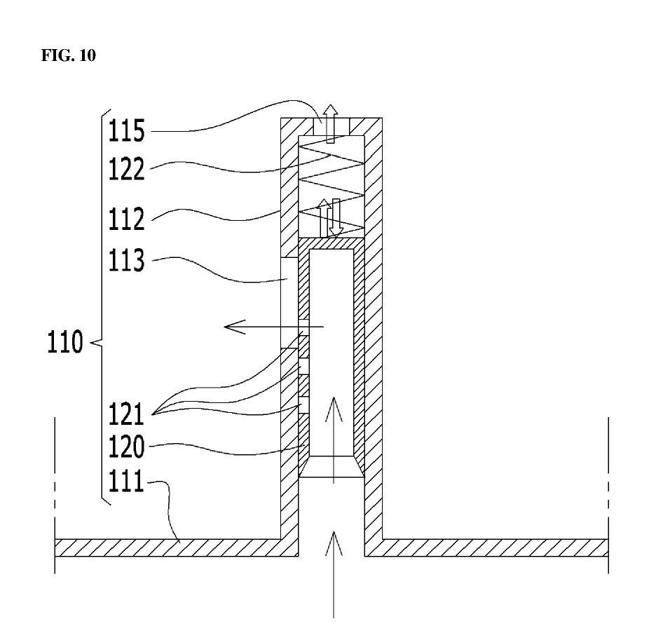

Referring to FIG. 10, the fuel peg 110 may have a structure in which an injection-adjusting member 120 and an elastic member 122 are further included.

Specifically, the injection-adjusting member 120 may have a hollow cylinder structure, which is slidably mounted in the extension part 112, and may include one side in which a plurality of through-holes 121 are formed at regular intervals in the sliding direction. It is preferable that the extension part 112 has a hollow cylinder structure, which extends inside the air channel 106 a predetermined length from the support part 111, and may include an upper end in which a through-hole 115 is formed and one side in which a fuel injection hole 113 is formed.

The elastic member 122 may be mounted between an upper surface of the injection-adjusting member 120 and an inner upper surface of the extension part 112 to provide an elastic restoring force of the injection-adjusting member 120 in the vertical direction.

The operation of the fuel peg 110 of FIG. 10 having such a configuration will now be described. As air flows around the fuel peg 110, an internal pressure of the extension part 112 is reduced through the through-hole 115 formed in the upper end of the extension 112. When the pressure of the space between the upper surface of the injection-adjusting member 120 and the inner upper end surface of the extending part 112 is reduced due to the flow of air, the injection-adjusting member 120 is sucked and lifted upward so that the through-holes 121 of the injection-adjusting member 120 communicate with the fuel injection hole 113 of the extension part 112.

As the injection-adjusting member 120 is sucked and lifted higher, the number of the through-holes 121 communicating with the fuel injection hole 113 increases, thereby increasing an amount of fuel injection.

As a result, the higher a flow speed or flow rate of air flowing around the fuel peg 110 increases, the greater an amount of fuel injection becomes.

For more effective operation, the injection-adjusting member 120 may have a structure corresponding to an inner structure of the extension part 112, with a sealing member (not shown) mounted between a lateral side of the injection-adjusting member 120 and the inner side of the extension part 112.

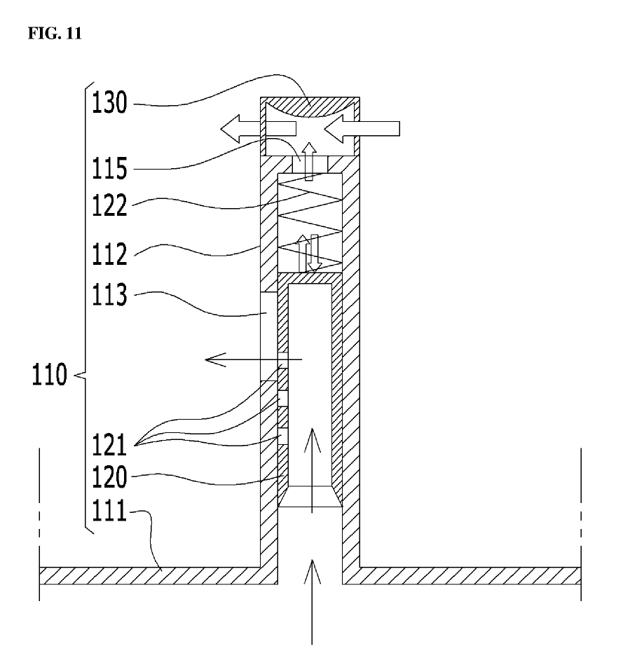

In some cases, as shown in FIG. 11, an auxiliary guide 130 may be further mounted on one end of the extension part 112 to more effectively improve the operation of the fuel peg 110 according to a flow of air. Specifically, the auxiliary guide 130 has a structure that is mounted on the upper end of the extension part 112 such that the auxiliary guide is convex by a predetermined distance in the direction of the through-hole 115 formed in the upper end of the extension part 112.

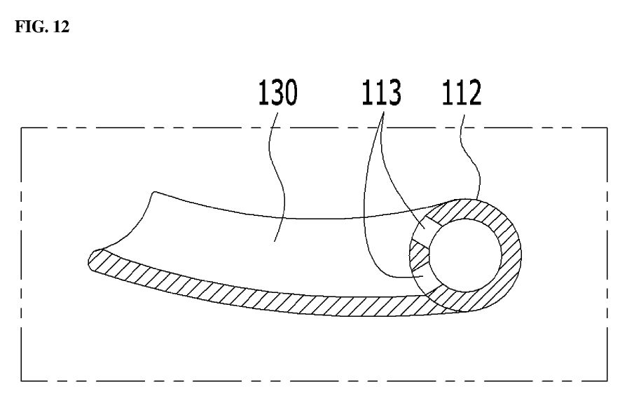

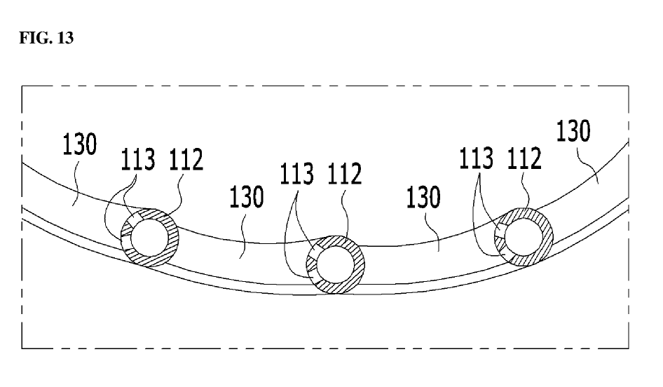

Referring to FIGS. 12 and 13, a curved airflow guide 140 for guiding air flowing along the inside of the air channel may be mounted on one side of the fuel peg 110.

Here, the airflow guide 140 may have a concave portion formed convexly toward the head end plate 102.

The air flow guide 140 has a concave portion curved corresponding to the inner surface of the nozzle casing 101, wherein the concave portion has a circular shape in cross section.

Optionally, as shown in FIG. 13, the airflow guide 140 may be integrally coupled to the adjacent fuel peg 110.

The present embodiment including such a configuration can smoothly guide the flow of compressed air through the airflow guide installed close to the head end plate, and can thus reduce the conventional problem of pressure loss caused due to a strong swirl produced by a rapid change in direction of a flow of compressed air, which helps provide an efficient supply of air for premixed combustion and increases the combustion efficiency, thereby improving the overall efficiency of a gas turbine.

The present invention can provide a gas turbine including the above-described combustor in which the difference between the direction of the air flow and the direction of the fuel flow is reduced so that the fuel is supplied to a desired region, thereby improving the fuel-air mixing ratio and thus the performance of the combustor.

Specifically, a gas turbine according to the present embodiment includes a compressor to compress air introduced from an outside; a combustor 100 to produce combustion gas by combusting a mixture of fuel and the compressed air; and a turbine to produce power using the combustion gas. Here, the combustor 100 may include the combustor according to any one of the above-described embodiments of the present invention.

While the exemplary embodiments of the present invention have been described in the detailed description, the present invention is not limited thereto, but should be construed as including all of modifications, equivalents, and substitutions falling within the spirit and scope of the invention defined by the appended claims.

That is, the present invention is not limited to the above-mentioned embodiments and the description thereof, and it will be appreciated by those skilled in the art that various modifications and equivalent embodiments are possible without departing from the scope and spirit of the invention defined by the appended claims and that the present invention covers all the modifications and equivalents falling within the spirit and the scope of the present invention as defined by the appended claims.

What is claimed is:

1. A combustor comprising:
a nozzle casing;
a head end plate coupled to one end of the nozzle casing and having a plurality of supply holes through which fuel and air are respectively supplied;
a nozzle assembly provided inside the nozzle casing and having a plurality of nozzles fixed to the nozzle end plate to receive the fuel and air from the supply holes and a nozzle cap having a plurality of through-holes surrounding the nozzles; and
a plurality of fuel pegs mounted inside the nozzle casing and disposed at predetermined intervals along an inner circumferential surface of the nozzle casing to inject the fuel into an air channel between the nozzles and the nozzle cap.

2. The combustor of claim 1, wherein the fuel peg includes:
a support part mounted on an inner surface of the nozzle casing and having a planar disk-shaped structure; and
an extension part extending a predetermined length inside an air channel from the support part and including one side in which a fuel injection hole is formed.

3. The combustor of claim 1, wherein the fuel peg has a cross-sectional structure formed as either one of an oval or airfoil structure curved in a direction corresponding to the direction of air flowing along the air channel.

4. The combustor of claim 3, further comprising a fuel injection hole formed in one side of the fuel peg in the direction corresponding to the direction of air flowing along the air channel.

5. The combustor of claim 4, wherein the fuel injection hole is formed at one end of the fuel peg.

6. The combustor of claim 1, wherein the fuel peg includes:
a support part mounted on an inner surface of the nozzle casing and having a planar disk-shaped structure;
an extension part extending a predetermined length inside an air channel from the support part; and
a fuel peg cap having a hemispherical structure mounted on one end of the extension part and including one side in which a fuel injection hole is formed.

7. The combustor of claim 6, wherein the fuel injection hole formed in the fuel peg cap is formed in a direction corresponding to the direction of air flowing along the air channel.

8. The combustor of claim 1, wherein the fuel peg includes:
a support part mounted on an inner surface of the nozzle casing and having a planar disk-shaped structure;
an extension part having a hollow cylinder structure extending a predetermined length inside an air channel from the support part, the extension part including an upper end at which a through-hole is formed and one side at which a fuel injection hole is formed;
an injection-adjusting member having a hollow cylinder structure slidably mounted in the extension part and including one side in which a plurality of through-holes are formed at regular intervals in a sliding direction; and
an elastic member mounted between an upper surface of the injection-adjusting member and an inner upper surface of the extension part to provide an elastic restoring force of the injection-adjusting member in a vertical direction.

9. The combustor of claim 8, further comprising an auxiliary guide extending convexly a predetermined distance from one end of the extension part in the direction of the through-hole formed in the upper end of the extension part.

10. The combustor of claim 8, further comprising a sealing member mounted between a lateral surface of the injection-adjusting member and an inner surface of the extension part, wherein the injection-adjusting member has a structure corresponding to an inner structure of the extension part.

11. The combustor of claim 8, wherein the fuel peg has a cross-sectional structure formed as either one of an oval or airfoil structure curved in a direction corresponding to the direction of air flowing along the air channel.

12. The combustor of claim 8, further comprising a fuel injection hole formed at one end of one side of the fuel peg in a direction corresponding to a direction of air flowing along the air channel.

13. The combustor of claim 8, wherein the fuel peg further includes a fuel peg cap having a hemispherical structure mounted on one end of the extension part and including one side in which a fuel injection hole is formed.

14. The combustor of claim 13, wherein the fuel injection hole formed in the fuel peg cap is formed in a direction corresponding to the direction of the air flowing along the air channel.

15. The combustor of claim 1, further comprising a curved airflow guide mounted on one side of the fuel peg to guide air flowing along the air channel.

16. The combustor of claim 15, wherein the airflow guide has a concave portion curved convexly toward the head end plate.

17. The combustor of claim 15, wherein the airflow guide has a concave portion formed in a curved surface in a shape corresponding to an inner surface of the nozzle casing.

18. The combustor of claim 17, wherein the concave portion has an arc-shaped cross section.

19. The combustor of claim 15, wherein the airflow guide is integrally coupled to the adjacent fuel peg.

20. A gas turbine comprising a compressor to compress air introduced from an outside; a combustor to produce combustion gas by combusting a mixture of fuel and the compressed air; and a turbine to produce power using the combustion gas, wherein the combustor comprises:
a nozzle casing;
a head end plate coupled to one end of the nozzle casing and having a plurality of supply holes through which the fuel and compressed air are respectively supplied;
a nozzle assembly provided inside the nozzle casing and having a plurality of nozzles fixed to the nozzle end plate to receive the fuel and compressed air from the supply holes and a nozzle cap having a plurality of through-holes surrounding the nozzles; and
a plurality of fuel pegs mounted inside the nozzle casing and disposed at predetermined intervals along an inner circumferential surface of the nozzle casing to inject the fuel into an air channel between the nozzles and the nozzle cap.
